(19) United States
(12) Patent Application Publication
(10) Pub. No.: US 2021/0056598 A1
(43) Pub. Date: Feb. 25, 2021

(54) Methods and Systems for Determining a Continuous Maintenance Condition of a Physical Man-Made Structure, and Associated Effective Year Built

(71) Applicant: BuildFax, Inc., Asheville, NC (US)

(72) Inventors: Sefton Patton, Asheville, NC (US); Holly Ward Tachovsky, Austin, TX (US); Zachery Wade, Breckenridge, CO (US); Daniel Kenney, Austin, TX (US)

(73) Assignee: BuildFax, Inc., Asheville, NC (US)

(21) Appl. No.: 16/996,646

(22) Filed: Aug. 18, 2020

Related U.S. Application Data
(60) Provisional application No. 62/994,665, filed on Mar. 25, 2020.
(60) Provisional application No. 62/888,835, filed on Aug. 19, 2019.

(51) Int. Cl. G06Q 30/02; G06Q 40/06; G06Q 50/16; G06Q 50/26; G06Q 30/00; G06Q 10/00; G06N 7/00; G06F 17/18

(52) U.S. Cl. CPC G06Q 30/0278; G06Q 40/06; G06Q 50/165; G06F 17/18; G06Q 30/018; G06Q 10/20; G06N 7/005; G06Q 50/26

(57) ABSTRACT

Apparatus and methods relate to applying a condition decay function to a property's initial investment value to generate numerical baseline condition scores for multiple predetermined time increments, and adjusting the baseline condition scores by investment value of property structure improvements occurring during each time increment and scaled according to a statistical distribution of values of property structure improvements to peer structures. Investment values may be calculated per square foot of structure. Investment values of an investment activity may be imputed according to a statistical distribution of investment values of peer structure investment activities. Adjusted condition score values may be scaled to standardized condition score values according to a predetermined quantile shift function for a property's jurisdiction(s). Effective age of a structure may be determined from condition score values. Exemplary embodiments may advantageously enable remote, objective evaluation of structure condition over time.

### CROSS-REFERENCE TO RELATED APPLICATIONS

This application claims the benefit of U.S. Provisional Application Ser. No. 62/888,835, titled “Methods and Systems for Determining a Continuous Maintenance Condition of a Physical Man-Made Structure, and Associated Effective Year Built,” filed by Sefton Patton, et al., on Aug. 19, 2019.

This application claims the benefit of U.S. Provisional Application Ser. No. 62/994,665, titled “Methods and Systems for Determining a Continuous Maintenance Condition of a Physical Man-Made Structure, and Associated Effective Year Built,” filed by Sefton Patton, et al., on Mar. 25, 2020.

This application incorporates by reference U.S. application Ser. No. 14/930,874, titled “Method of Using Building Permits to Identify Underinsured Properties,” filed by Joseph Tierney Masters Emison, on Nov. 3, 2015, which is a Continuation-in-part of U.S. application Ser. No. 14/185,215, titled “Computer-Implemented Method for Estimating the Condition or Insurance Risk of a Structure,” filed by Joseph Tierney Masters Emison, on Feb. 20, 2014.

This application incorporates the entire contents of the foregoing application(s) herein by reference.

### TECHNICAL FIELD

Various embodiments relate generally to building and structure maintenance modelling.

### BACKGROUND

Physical man-made structures may decay over time after they are initially created. Structures may deteriorate over time due to exposure to elements, and type of building material. Systems associated with the structure may deteriorate. Various entities may wish to evaluate condition of a physical man-made structure.

### SUMMARY

Apparatus and methods relate to applying a condition decay function to a property's initial investment value to generate numerical baseline condition scores for multiple predetermined time increments, and adjusting the baseline condition scores by investment value of property structure improvements occurring during each time increment and scaled according to a statistical distribution of values of property structure improvements to peer structures. Investment values may be calculated per square foot of structure. Investment values of an investment activity may be imputed according to a statistical distribution of investment values of peer structure investment activities. Adjusted condition score values may be scaled to standardized condition score values according to a predetermined quantile shift function for a property's jurisdiction(s). Effective age of a structure may be determined from condition score values. Exemplary embodiments may advantageously enable remote, objective evaluation of structure condition over time.

Exemplary embodiments may provide various advantages. In an illustrative embodiment, condition of a target structure may be objectively evaluated over time. In illustrative embodiments the condition of target structures may be remotely evaluated and compared over time. Exemplary embodiments may enable evaluation related to estimated remaining life on a structure, on various key systems for buildings and other structures, or both. Illustrative embodiments may advantageously yield highly valuable information and insight, which various decision-makers may leverage to make more informed decisions, and minimize overall propensity for loss. Illustrative embodiments may advantageously compare an actual age of a structure to an effective age based off of property structure improvements. Illustrative embodiments may advantageously enable records to be evaluated which do not include investment value. Illustrative embodiments may advantageously compare structures across jurisdictions.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a diagram of an exemplary continuous condition score process.

FIG. 2A depicts a diagram of an exemplary computing system for determination of a continuous condition score and/or effective age associated with a specific man-made physical structure.

FIG. 2B depicts a flowchart of an exemplary first embodiment of a continuous condition score determination process.

FIG. 3 depicts graphs of exemplary continuous condition score curves, each curve being associated with a specific man-made physical structure.

FIG. 4A depicts a flowchart of an exemplary second embodiment of a continuous condition score and effective age determination process.

FIG. 4B depicts a table with exemplary data illustrating application of the process in FIG. 4A.

FIG. 5A depicts a flowchart of an exemplary third embodiment of a continuous condition score and effective age determination process.

FIG. 5B depicts a table with exemplary data illustrating application of the process in FIG. 5A.

FIG. 6A depicts a flowchart of an exemplary fourth embodiment of a continuous condition score and effective age determination process.

FIG. 6B depicts a table with exemplary data illustrating application of the process in FIG. 6A.

FIG. 7 depicts a diagram of an exemplary jurisdictional condition score shift scenario.

FIG. 8 depicts a flowchart of an exemplary computer-implemented jurisdictional score shift process.

FIG. 9 depicts a flowchart of an exemplary computer-implemented value imputation process.

Like reference symbols in the various drawings indicate like elements.

### DETAILED DESCRIPTION OF ILLUSTRATIVE EMBODIMENTS

When a structure on property is initially constructed (whether residential or commercial), the structure and its components have an initial quality and performance that may statistically accompany new construction at a given point in time. Property maintenance, when done in accordance with local building code guidelines, may make older structures “behave” like newer ones, particularly when it comes to the most common causes of loss like fire, water, storms, wind, hail, and physical hazards that can cause human harm. Conversely, as time progresses across a number of owners, various structures and their component systems may start to deteriorate, due to responsible parties not taking necessary measures to ensure these systems are well maintained, in good working order, and safe for inhabitants. Using these insights, various systems and methods disclosed herein may determine a metric (or score) that relates to an estimated remaining life on various key systems (such as roofs, electrical systems, HVAC systems, and plumbing, for example) for buildings and other structures. Such systems and methods may advantageously yield highly valuable information and insight, which various decision-makers may leverage to make more informed decisions, and minimize overall propensity for loss.

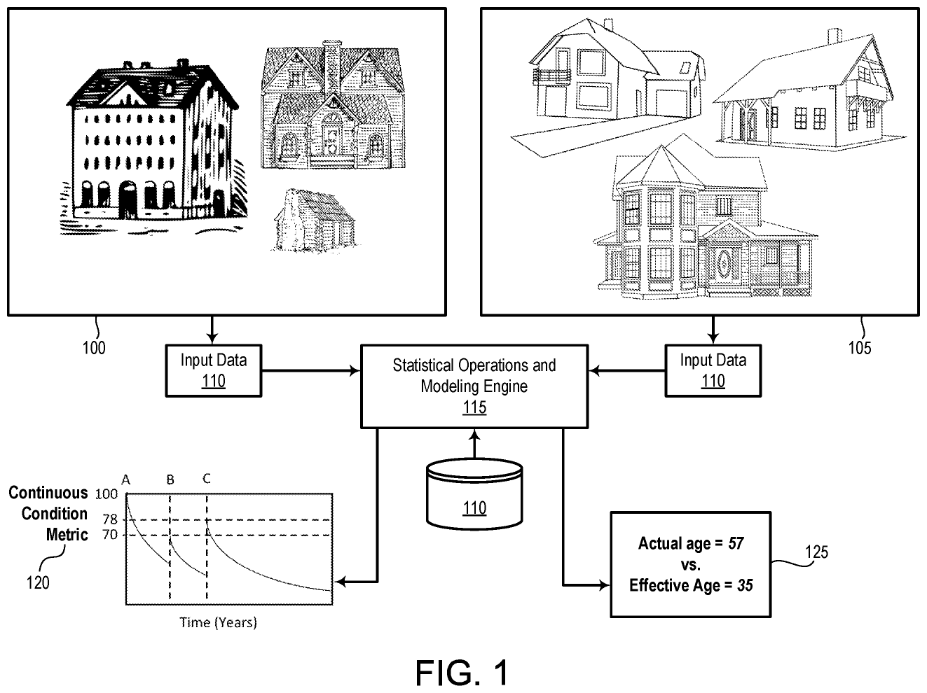

FIG. 1 depicts a diagram of an exemplary continuous condition score process. The diagram shows a first set of structures 100 and a second set of structures 105. The first set of structures 100 include structures that may have not been well maintained over each structure's life. For example, some of the structures 100 may have never undergone support or structural repairs, or never had the HVAC or plumbing systems replaced. In contrast, the second set of structures 105 includes structures that have been well maintained over each structure's life. For example, the structures 105 may have had electrical and HVAC systems updated, been reroofed, and/or been remodeled. As such, all structures 100, 105 may start out with an initial “baseline” score that decays over time and represents the wear and tear on the structure, with structures 105 maintaining a relatively “high” score (because they are well maintained), and the structures 100 falling down over time to a relatively “low” score (because they are being poorly maintained). Furthermore, while some of the structures 100 may be the same actual age as some of the structures 105, the structures 105 may have a significantly lower “effective age,” due to the fact that the structures 105 have been relatively well maintained, while the structures 100 have not been well maintained. Accordingly, various systems and methods disclosed herein may generate a “continuous condition score” that indicates an estimated (and normalized) level of upkeep or maintenance for a given structure located on a given property, as well as determining an “effective age” of a given structure located on a given property, using information contained in a large quantity of source data records.

To illustrate, as shown in FIG. 1, information about the structures 100, 105 may be used as input data 110. The information about the structures may be extracted from various data sources (e.g., databases), such as those data sources described in, for example, FIG. 1 and [0051-0077] of U.S. application Ser. No. 14/185,215 titled “Computer-Implementer Method for Estimating the Condition or Insurance Risk of a Structure,” filed by Joseph Tierney Masters Emison, on Feb. 20, 2014, the entire contents of which is incorporated herein by reference. The input data 110 may be fed into a statistical operations and modeling engine 115. The engine 115 may then perform various computing operations to generate outputs 120, 125.

The output 120, in this exemplary illustration, is a graph showing a continuous condition score curve associated with a given man-made physical structure or building. As shown in the graph 120, the score starts out at a maximum value (at time A) and decays over time. At time B, however, the score then “jumps” up to a higher value, and then starts to decay from that higher value. This “jump” in the condition score may be associated with a significant improvement to the man-made structure, such as roof replacement or remodel, for example. At time C, the score jumps again to a higher value, signifying yet another significant improvement. In some examples, not all improvements may result in an appreciable change in the score, because some improvements are so minute that they really do not “move the needle” on the overall condition of a building.

The output 125, in this exemplary illustration, is an “effective age” of the specific structure or building, that may be derived from the continuous condition score output 120. The effective age 125 in this case, is compared with an actual age. In this example, the actual age of the specific structure is 57 years, while the determined effective age is only 35 years. Therefore, the associated condition score curve for this structure may have had at least one significant improvement over its lifetime, such that the structure may look or behave “younger” than it actually is. Accordingly, an end-user may advantageously make a more informed decision using the generated outputs 120, 125 without even needing to perform a manual and cumbersome physical inspection of the property and structure, as the user now has valuable insight into whether a given structure on a given property has a highly maintained condition, an averagely maintained condition, or a poorly maintained condition, for example.

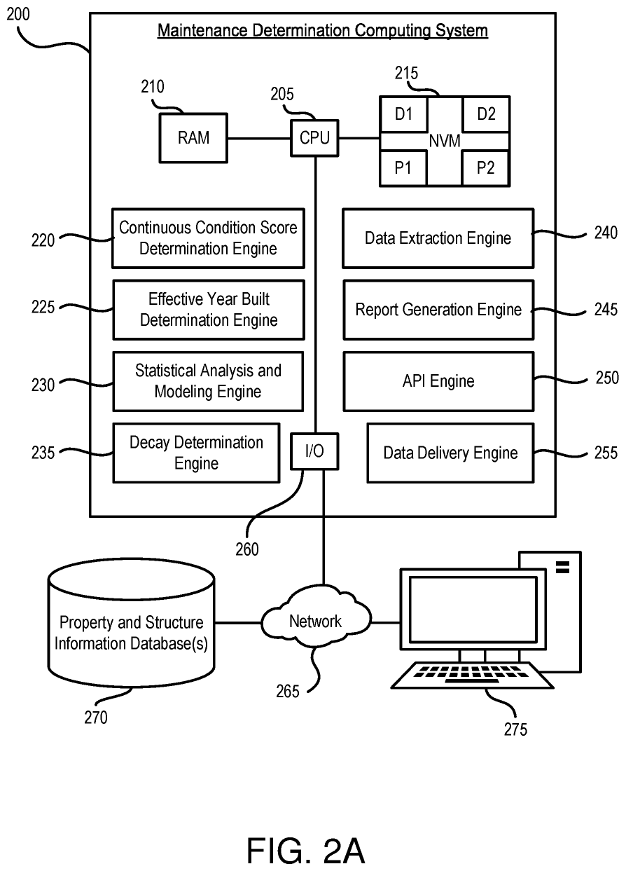

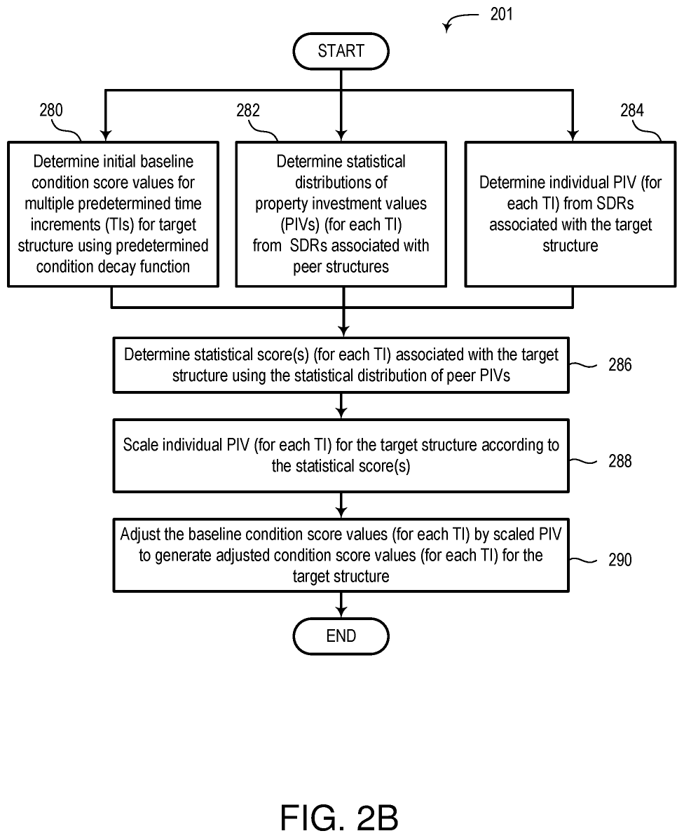

FIG. 2A depicts a diagram of an exemplary computing system for determination of a continuous condition score and/or effective age associated with a specific man-made physical structure. A maintenance determination computing system 200 includes at least one CPU 205, random-access memory (RAM) 210, and non-volatile memory (NVM) 215. The CPU 205 is coupled to input/output (I/O) 260, which may include a computer display screen or network connection port, for example. Included with the system 200 may be several engines, which may be implemented using computer executable program instructions stored on a non-transitory computer readable medium, such as a solid-state hard drive, for example. For example, a “continuous condition score” determination engine 220 may perform operations to determine a continuous condition score, such as the graphically depicted score shown in FIG. 1, output 120. An “effective year built” determination engine 225 may perform operations to determine an effective year built, such as the graphically depicted effective year built shown in FIG. 1, output 125. The engines 220, 225 may rely, in part, on a statistical analysis and modeling engine 230 that executes various data processing operations such as standard deviation calculations, for example. The engines 220, 225, 230 may rely, in part, on a decay determination engine 235 that performs operations to determine an estimated decay in structure maintenance using a decay function, such as an exponential, linear, or gamma decay process, for example.

While engines 220-235 may perform core operations in determining various parameters for the system 200, a number of engines 240-255 may be used to facilitate or support these core operations. For example, a data extraction engine 240 may perform operations to extract (raw) data from various sources, such as various property and structure information database(s) 270. The raw data may be used as inputs into various computer-implemented processes disclosed herein. A report generation engine 245 may execute operations to generate a report that includes various information and/or parameters, such as an “effective year built” and “continuous condition score” for a specific building or structure, for example. An API engine 250 may perform application programming interface operations to interface the capabilities of the system 200 with other computer systems. A data delivery engine 255 may perform operations to transmit data generated by the system 200 to various other systems, such as to a client computer 275 over a network 265, for example.

In an illustrative example, the system 200 may first extract various data from various sources, such as property and structure information database(s) 270 via the I/O 260 and network 265. The system 200 may then store this extracted information in NVM 215. Next, the system 200 may initialize the various engines to generate a “continuous condition score” that indicates an estimated (and normalized) level of upkeep or maintenance for a given structure located on a given property, as well as determining an “effective age” of a given structure located on a given property, using stored information in NVM 215. For example, the system 200 may be configured to generate outputs 120, 125 from FIG. 1 using the engines 220 and 225 (and perhaps engines 230 and 235), which may then be curated into a report generated by the report generation engine 245, which is then transmitted via the I/O 260, across network 265, to the client device 275 for final consumption.

The continuous condition scores and effective age (eYearBuilt) generated by the system 200 may represent a smarter deterioration measure on properties that accounts for the natural decay of structures, properties, and buildings, but reacts favorably when these systems are maintained or improved upon. In order to accomplish this, a metric that benchmarks the condition of all properties that have associated building permit data is generated. The continuous condition score may objectively consider permit activity throughout the life of a subject property, relative to other properties of the same type and age, for example. The valued output of the system may be a continuous number bounded between 100 and 0, in an exemplary implementation, which may be granular and capable of delivering more precise modeling capabilities in a variety of scenarios. In addition to this, continuous condition measure may be converted into an “effective age” (or “effective year built”), which may be an age that is equal to, older, or younger than the property's actual age, based on the types and significance of maintenance work that has been performed on over time.

FIG. 2B depicts a flowchart of an exemplary embodiment of a continuous condition score determination process. A process 200 may be executed by a computer processor (e.g., CPU 205) according to computer instructions stored in memory (e.g., NVM 215). A specific target structure may be selected, for which source data records (SDRs) exist in one or more data stores. The SDRs may, for example, include building permits. The building permits may be from one or more sources, including from multiple jurisdictions. Each SDR may relate, for example, to property structural investment (PSI) records which may include, for example, repairs, maintenance, upgrades, additions, remodeling, or other investment activities physically altering one or more man-made physical structures. The SDRs may have or be related to property investment values (PIVs). A PIV, for example, may include a cost associated with at least one PSI (e.g., a ‘job cost’), may be determined from one or more characteristics of the SDR (e.g., an inspection or permit fee which may be determined according to a cost per square foot of the PSI or a total cost of the PSI), or may be imputed based on the PSI according to aggregated data. The SDRs may be, or have previously been, retrieved from a plurality of data stores (e.g., a central database, a cloud storage provider, from one or more code enforcement jurisdictions, or from one or more vendors or repositories of code enforcement records).

For a specific target structure, initial baseline condition score values are determined 280 for multiple predetermined time increments (TIs), using a predetermined condition decay function. The predetermined TIs may, for example, be each year since the year the target structure was built. The TIs may represent an entire lifetime of a structure, or a specific portion thereof. The TIs may be annual, monthly, or otherwise, and may be periodic (e.g., ever year, two years, ten years, six months, or other time increment) or sporadic (e.g., according to when SDRs are available). The initial baseline condition score is established for each predetermined TI. The baseline condition score is established according to a predetermined time decay function. In various embodiments, the condition decay function may, for example, represent an exponential, linear, or gamma decay process.

Statistical distributions of PIVs are determined 282 from SDRs associated with peer structures. The peer structures may be selected, for example, based on similarity in one or more characteristics. Characteristics may include, by way of example and not limitation, age, location (e.g., proximity, neighborhood, urban vs rural vs suburban), size, initial value, type (e.g., residential, single-story, multi-story, multi-family, commercial, industrial, retail), builder, or associated plot size. Statistical distributions may be determined, for example, by computing a cumulative investment for each property in a peer group. The cumulative investment may be determined per square foot, which may advantageously aid accuracy of comparison between structures of varying sizes. Square footage data may, for example, be sourced from SDRs such as tax assessor records. Year built may, for example, be determined from SDRs such as a year built value in a building permit record, from tax assessor records, or some combination thereof.

The statistical distribution may be a normal distribution of cumulative investment value of the peer group, for each predetermined TI. In some embodiments, TI may be correlated relatively instead of absolute (e.g., by year from date built—1^{st} year, 2^{nd} year, 3^{rd} year, and so on—rather than 2018, 2019, 2020). Such embodiments may advantageously select peer structures which may not have been built in a same year, but which may advantageously provide a more accurate normalization of PIV. For example, a normal distribution may represent a distribution of ‘quality’ (e.g., according to PIV per TI) across all properties at a given age. In some embodiments, a statistical distribution may be pre-calculated and so be determined by selection and retrieval from at least one data store.

Individual PIVs are determined 284 for each TI from SDRs associated with the target structure. The PIVs may, for example, be calculated per unit area. The PIV for a specific TI may represent multiple SDRs, may represent multiple PSIs, or both. In some TIs, for example, the PIV may be zero (e.g., if no PSI occurred). Once a baseline condition score value, a statistical distribution(s) of cumulative PIV for peer structures, and an individual PIV for the target structure are determined for each TI, at least one statistical score is determined (286) for each TI. The statistical score may, for example, be a z-score correlating the individual PIV to a normal distribution of peer structure PIVs for that TI.

The statistical score(s) for each TI is then used to scale 288 the corresponding individual PIV according to the peer structures. Finally, the baseline condition score values are adjusted 290 by the scaled PIV for each TI to generate an adjusted condition score value for each TI for the target structure. In some embodiments, step 290 may include at least one intermediate step (not shown), in which the baseline condition score value is updated, for example, after the statistical distribution of peer structure PIVs for each TI are determined, thereby generating updated baseline condition score values adjusted according to a distribution of peer structure PIVs. The final adjusted condition score values across a predetermined number of TIs, may advantageously provide an accurate estimation of the target structure's condition. For example, an insurance company or potential purchaser may advantageously and objectively evaluate the target structure's condition, and compare it to other structures using an objective indicia. The condition may, for example, be evaluated entirely remotely and avoid the inconvenience and cost of evaluating the structure(s) in person. This method for objectively determining continuous condition score values across multiple time increments may advantageously minimize or eliminate inaccuracies and discrepancies due to appraiser differences, subjective evaluations, deterioration or improvements not seen during a visual inspection, and other similar difficulties.

For a given target structure, for example, the baseline condition score may initially be calculated by a predetermined decay function, generating a smooth and continuous series of points across multiple TIs. The PSIs (measured in PIV) applied to that target structure (e.g., at least partially from building permit records) may then be compared to the PSI applied to peer structures, and the relative improvement or deterioration reflected in adjusted condition score values. For example, if a target structure has been maintained better than peer structures, as represented by higher PIVs in various TIs, the condition score value will be adjusted upwards in those TIs. The upwards adjustment will be reflected in subsequent TIs—in other words, an improvement in one TI affects all subsequent TIs. In another example, if a target structure has been maintained less than peer structures, as represented by lower PIVs in various TIs, the condition score values will be adjusted downwards in those TIs, which will likewise be reflected in subsequent TIs.

The condition score value may be affected by the peer structures selected. For example, a target structure may have higher adjusted condition score values when compared to a national peer group then it will when compared to a highly-maintained peer (group relative to the national peer group). Although, ‘higher’ and ‘upwards’ may be used in various examples to indicate ‘better’ (more preferred, better maintained) structures, and ‘lower’ and ‘downwards’ may be used to indicate ‘worse’ (less preferred, less maintained) structures, the condition score value method may not rely thereon. Indeed, some condition score values may be configured such that a lower value represents a better maintained structure.

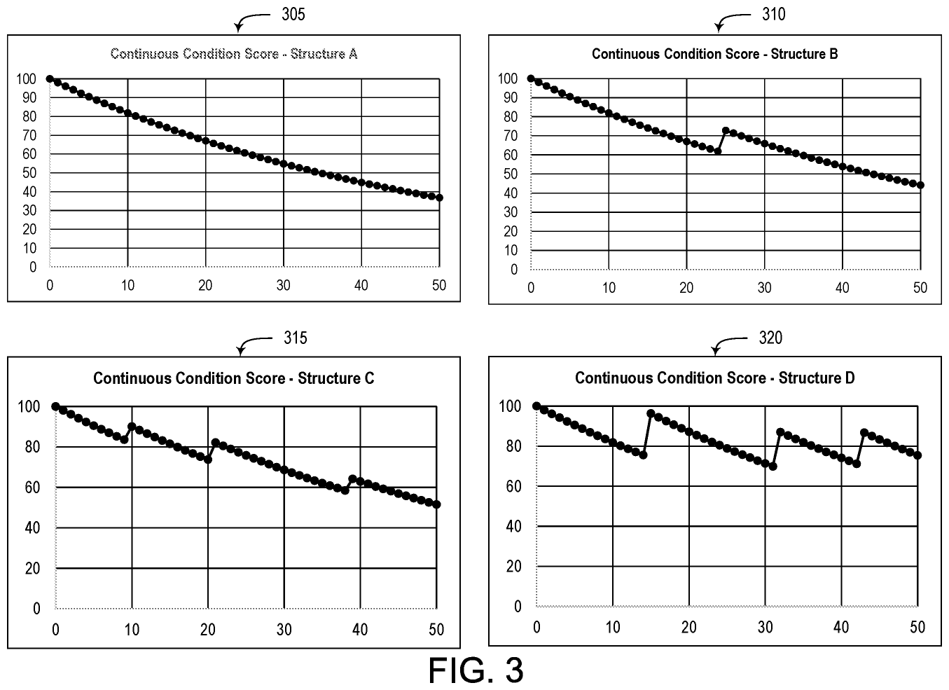

FIG. 3 depicts a graph of an exemplary continuous condition score curve associated with a specific man-made physical structure. The graphs may indicate a time-dependent continuous condition score on a scale of 0-100, although other scaling options are possible. A first graph 305 includes a first continuous condition curve associated with a first structure (Structure A). In this example, the first curve exhibits a decay and monotonic decline. Such a curve may be associated with a structure (Structure A) having zero significant maintenance over the life of the structure. The first curve may therefore be representative of a typical curve for those buildings in the set of structures 105 (as visual inspection confirms that these buildings clearly have not been maintained over each of their lifetimes). A second graph 310 includes a second continuous condition curve associated with a second structure (Structure B). In this example, the second curve exhibits a decay and (mostly) monotonic decline, with the exception of a “jump” at around year 25. Such a curve may be associated with a structure (Structure B) having only a single significant maintenance event over the 50-year life of the structure (such as a remodel around year 25, for example). The second curve may therefore be representative of a typical curve for those buildings in the set of structures 105 (as visual inspection confirms that these buildings clearly have not significantly been maintained over each of their lifetimes).

In contrast to graphs 305, 310, graphs 315 and 320 visually indicate that the buildings/structures associated with these graphs have experienced more significant improvement and necessary maintenance events over the lifetimes than the structures associated with graphs 305, 310. For example, a third graph 315 includes a third continuous condition curve associated with a third structure (Structure C). In this example, the first curve exhibits a decay and non-monotonic decline, as there are three different “jumps” in the score curve depicted in this graph. Such a curve may be associated with a structure (Structure C) having three significant maintenance events over the life of the structure. However, because each improvement to Structure C was not a “major” improvement, the “jumps” may be significant but not large relative to the score in a pre jump year (or insignificant relative to the typical maintenance done by property peers in the same year).

A fourth graph 320 includes a fourth continuous condition curve associated with a fourth structure (Structure D). In this example, the fourth curve exhibits a decay and non-monotonic decline. Such a curve may be associated with a structure (Structure D) having multiple highly significant maintenance events over the 50-year life of the structure (such as full remodels/renovations approximately every 15 or so years). The fourth curve may therefore be representative of a typical curve for those buildings in the set of structures 110 (as visual inspection confirms that many of these buildings have experienced many highly significant improvements/updates that drastically increase the value of, or decrease the natural decay of, the structure). Accordingly, while the 50-year continuous condition score of Structures A, B, and C may ultimately fall to around a score of 50 on a 100-point scale, the 50-year continuous condition score of Structure D is much higher at around 70 on a 100-point scale. Therefore, an end-user in receipt of a continuous condition score for a given building or man-made structure may have a much better indication of the state of that man-made structure (e.g., whether the structure's condition more like graph 305 or 310, or more like graph 320).

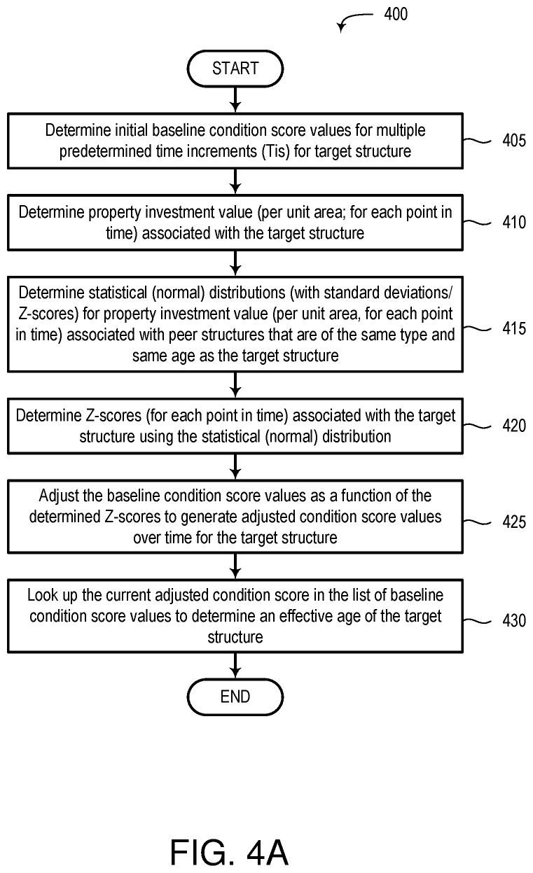

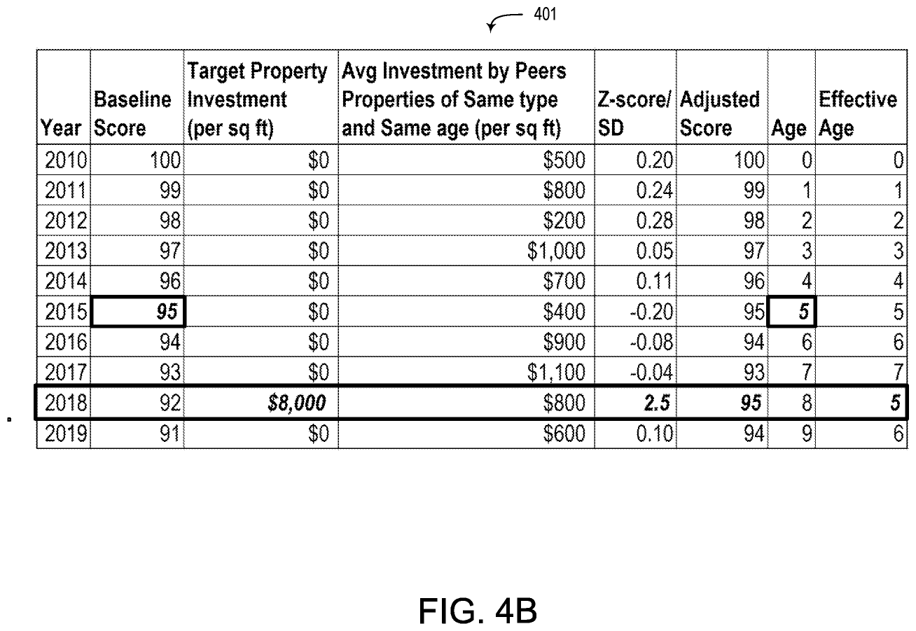

FIG. 4A depicts a flowchart of an exemplary second embodiment of a continuous condition score and effective age determination process. A process 400 may be executed by a computer processor (e.g., CPU 205) according to computer instructions stored in memory (e.g., NVM 215). In an exemplary aspect, two primary assumptions may factor into the modeling of the continuous condition score. A first assumption may be that the useful life of a given property, given zero maintenance activity throughout the life of the property, may be a fixed/predetermined useful life time period (e.g., 100 years of assumed/predetermined useful life). A second assumption may be that the half-life of a property (when subject to exponential decay) may be a fixed/predetermined useful-life half-life (e.g., a useful-life half-life of 50 years). In some examples, a continuous condition score may consider building decay according to a linear function or gamma process.

As shown in FIG. 4A, the process 400 starts at step 405 with initialization of a set of baseline condition scores over time (e.g., each year) for a given target structure using a predetermined decay function (e.g., an exponential function). The baseline score for each year a property has existed is computed uniformly given the assumptions above. As a result, all properties of a given age may have an identical baseline condition score. Next, at step 410, the process determines a property investment value associated with the target structure. The property investment value may be an investment amount in permitted projects, per unit area, for each year of the target property's existence. Next, at step 415, the process determines statistical distributions for property investment value associated with peer structures that are of the same type and same age as the target structure. The statistical distributions may be assumed to be a normal distribution, in some examples. A given determined distribution may be represented as investment per unit area for a given year across properties with a same (or similar) age and same (or similar) type of structure. Next, at step 420, the process determines Z-scores (for each point in time) associated with the target structure using the determined statistical distribution. Next, at step 425, the baseline condition scores are then adjusted by the respective z-scores of investments in permitted projects for the target property to generate a set of actual (final) condition score values over time for the target property. This results in the Continuous Condition Score.

Because the generated Continuous Condition Score considers a useful life of a property, the generated score may be converted into an “effective age” (or “effective year built”) of the target structure as well. At step 430, the process may use the current actual condition score (e.g., in the present year) to look up a closest baseline condition score (determined at step 405). The closest baseline condition score to the current actual condition score may be associated with an actual age of the structure. This associated actual age may then be used as the “effective age” of the target structure.

FIG. 4B depicts a table 401 with exemplary data illustrating application of the process in FIG. 4A. In a first column is a list of points in time (e.g., years). In this exemplary depiction, a target structure was built in 2010, and the present year is 2019. Therefore, per step 405, the process 400 will generate a set of baseline condition scores (second column) for the target structure. In a third column is a list of investments in the target structure/property by year (per step 410). These investment values may be collected from records stored in at least one database, for example. In this case, no investments were made in the target structure until 2018, where an investment of $8,000 was made. At step 415, the process 400 determines the parameters of statistical distributions for property investment value associated with peer structures that are of the same type and same age as the target structure. In this example, the distributions are normal distributions with mean values for each year listed in the fourth column. Next, at step 420, the process will determine z-scores associated with the target structure that are relative to the underlying distributions determined in the previous step. For example, the fifth column includes a list of z-scores associated with the target structure for each year of the structure's existence. Since, in this case, there was no investment in the target structure in years 2010-2017, the determined z-scores for these years is about 0 (+/−some error). However, in 2018, a major job valued at $8,000 results in the z-score for that year being 2.5 standard deviations (>95%). Therefore, because the z-score for this year is so large (e.g., above a predetermined standard deviation threshold), then this investment may be considered a “significant” investment that affects the adjusted/actual/final condition score (sixth column). Therefore, for year 2018, the baseline score (second column) is adjusted as a function of the determined z-score to generate an actual or adjusted condition score, per step 425. In this case, the z-score may be simply added to the baseline score for 2018 to arrive at the adjusted score. Therefore, in 2018, the target structure's baseline score may be only 92, but the adjusted/actual score may be at around 95. Accordingly, the major improvement on year 2018 may result in a “jump” in the continuous condition score of the target structure, similar to the jumps depicted in FIG. 3, which may represent a significant improvement in the overall quality and physical condition of the target structure.

Furthermore, the adjusted continuous condition score may be used to determine an “effective age” of the target structure (eighth column, vs. the actual age in the seventh column). For example, the adjusted score at year 2018 is 95. According to step 430 then, the process will look up the value 95 (or the value closest to 95) in the set of baseline scores (second column). In this case, the value 95 in the second column is associated with the year 2015. The process may then use this year as the effective age of the target property (because with the improvements in 2018, the structure/property “looks” or “acts” younger than it actually is). In this case, since the target structure was built in 2010 and its condition in 2018 is essentially the same as the condition in 2015, the process may then determine that, while the actual age of the structure in 2018 is really 8 years old, the “effective age” may only be 5 years old (as this was how old the structure was back in 2015 when the baseline score was close to the actual/adjusted score in 2018). Accordingly, the effective age of this exemplary target structure may match the actual age up until the point when there is a major job/improvement that significantly increases the physical condition of the target structure, at which point the effective age may “jump” down to a “younger” effective age.

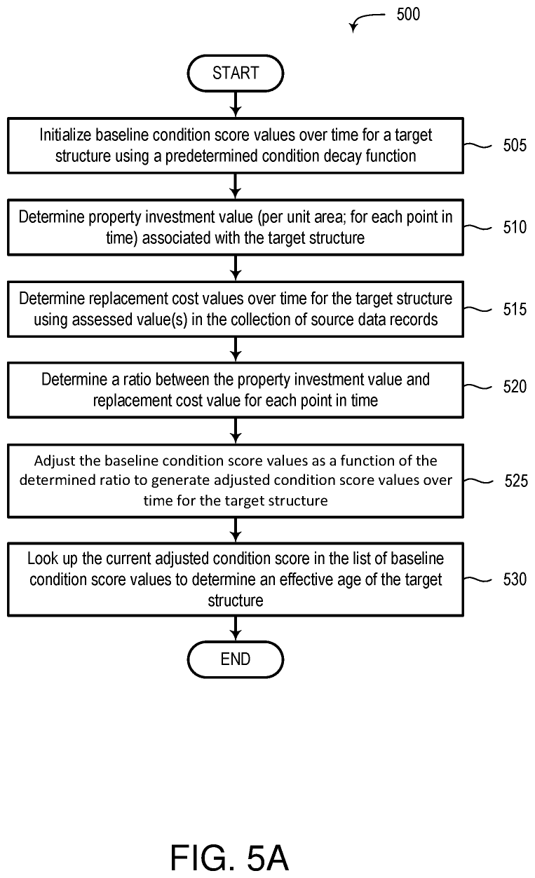

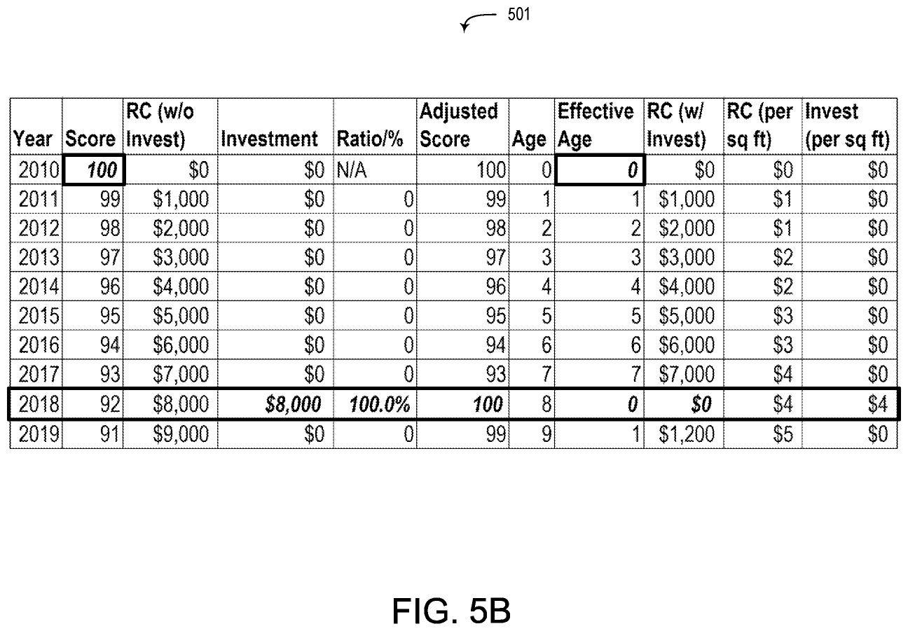

FIG. 5A depicts a flowchart of an exemplary third embodiment of a continuous condition score and effective age determination process. A process 500 may be executed by a computer processor (e.g., CPU 205) according to computer instructions stored in memory (e.g., NVM 215). The process 500 starts at step 505 with initialization of a set of baseline condition scores over time (e.g., each year) for a given target structure using a predetermined decay function (e.g., an exponential function). The baseline score for each year a property has existed is computed uniformly given the assumptions above. As a result, all properties of a given age may have an identical baseline condition score. Next, at step 510, the process determines a property investment value associated with the target structure. The property investment value may be an investment amount in permitted projects, per unit area, for each year of the target property's existence. Next, at step 515, the process determines a set of replacement cost values over time for the target structure, using assessed values in the collection of data source records. For example, one of the source data records may be tax records that include the tax-assessed value of the target property. Another source data record may include the tax-assessed land value associated with the target property. A difference between the tax-assessed value and the tax-assessed land value may yield a “replacement cost” for the target structure in any given year. This replacement cost value may effectively represent the amount of resources required to make the target structure “good as new” (e.g., from making the current continuous condition score of the target structure back up to “100”). Next, at step 520, the process determines a ratio between the determined property investment value in each point in time and the determined replacement cost in point in time. Next, at step 525, the baseline condition score for each point in time is adjusted by the determined ratio, to generate adjusted/actual/final condition score values over time for the target structure. The final scores may then reflect how each improvement to the target structure improves the physical condition of the target structure, relative to the replacement value of the property as a function of time.

Because the generated Continuous Condition Score considers a useful life of a property, the generated score may be converted into an “effective age” of the target structure as well. At step 530, the process may use the current actual condition score (e.g., in the present year) to look up a closest baseline condition score (determined at step 405). The closest baseline condition score to the current actual condition score may be associated with an actual age of the structure. This associated actual age may then be used as the “effective age” of the target structure.

FIG. 5B depicts a table 501 with exemplary data illustrating application of the process in FIG. 5A. In a first column is a list of points in time (e.g., years). In this exemplary depiction, a target structure was built in 2010, and the present year is 2019. Therefore, per step 505, the process 500 will generate a set of baseline condition scores (second column) for the target structure. In a fourth column is a list of investments in the target structure/property by year (per step 510). These investment values may be collected from records stored in at least one database, for example. This column may represent the replacement cost of the structure not factoring in the investment into the property. In this case, no investments were made in the target structure until 2018, where an investment of $8,000 was made. At step 515, the process 500 determines a set of replacement cost values over time for the target structure, using assessed values in the collection of data source records. In this case, a difference in each year between the tax-assessed value and the tax-assessed land value yields a replacement cost (third column) for the target structure in any given year. This replacement cost value may effectively represent the amount of resources required to make the target structure “good as new” (e.g., from making the current continuous condition score of the target structure back up to “100”). Next, at step 520, the process determines a ratio between the determined property investment value in each point in time and the determined replacement cost in that point in time (fifth column). In this case, the ratio is zero for each year except 2018, because 2018 was the only year that work was performed on the property (as determined by the retrieved source data records stored in memory). In 2018, an investment of $8,000 was made in the target structure. In 2018, the replacement cost for the target structure also happens to be $8,000. The target structure has been improved/upgraded/remodeled to a sufficient level, such that the 2018 investment fully accounts for the 2018 replacement cost of the property, as represented by the calculated ratio of 100%. Therefore, the process 500 at step 525, adjusts the baseline condition score values (first column) as a function of the determined ratio, to generate adjusted/actual/final condition score values over time for the target structure. The adjustment, in at least one exemplary embodiment, may be made according to the following equation:

$$S c o r {e}_{N e w} = S c o r {e}_{Init} + ( \frac{{Δ}_{\$ A c t u a l}}{{Δ}_{\$ F u l l}} * {Δ}_{ScoreFull} )$$

Where ScoreInit is the initial score (at time t), ScoreNew is the (upward) adjusted score (at time t+1), Δ$Actual is the actual investment made into the property (around time t), Δ$Full is the amount of investment needed to make the property look fully new again, and ΔScoreFull is the difference between the initial score (at time t) and the maximum possible score (e.g., 100 on a 0-100 scale). To provide an illustrative example, suppose that in a given year, full replacement cost for a $200,000 home is $200,000 (which assumes a full replacement cost if the property was completely destroyed, not replacement cost as of a given year). Considering natural decay, assume in a given year that it would take $20,000 to bring this property back to “brand new” (Δ$Full=$20,000). In this same year, the owner of the property does $10,000 worth of improvements (Δ$Actual=$10,000). Furthermore, in this same year, the (initial) score of the property is 80 on a 0-100 scale (ScoreInit=80; ΔScoreFull=100−80=20). Therefore, using the above numbers, the new score (at time t+1) for this property is:

$$S c o r {e}_{N e w} = 80 + ( \frac{\$10 , 000}{\$20 , 000} * 20 ) = 80 + ( 0.5 * 20 ) = 80 + 10 = 90$$

As such, since the property owner in the above case performed 50% of the work required to make the property look brand new ($10,000/$20,000), the score for the property is adjusted up by 50% of the difference between the total replacement cost and initial/instantaneous replacement cost (50%*(100−80)). Accordingly, all things being equal, if the actual age of this property is 6 years old, and the owner performed 50% of the work required to make the property like new again, the present method would drift the condition score by 50% of the age delta/difference (in this case, drift the effective age of the property to 3 years old=6 years old*50%).

In the example shown in FIG. 5B, the adjusted score is equal to the baseline score up until year 2018 (as there was no investment in the target structure up until this point). At 2018 however, the generated adjusted score is 100, which reflects that the $8,000 investment in the structure in 2018 has essentially improved the structure such that the quality of the structure “looks like” a newly constructed building (e.g., the target structure is estimated to be in the same physical condition as it was when it was originally built). Therefore, in 2018, the target structure's baseline score may be only 92, but the adjusted/actual score may be at 100. Accordingly, the major improvement on year 2018 may result in a “jump” in the continuous condition score of the target structure, similar to the jumps depicted in FIG. 3, which may represent a significant improvement in the overall quality and physical condition of the target structure.

Furthermore, the adjusted continuous condition score may be used to determine an “effective age” of the target structure (eighth column, vs. the actual age in the seventh column). For example, the adjusted score at year 2018 is 100. According to step 530 then, the process will look up the value 100 (or the value closest to 100) in the set of baseline scores (second column). In this case, the value 100 in the second column is associated with the year 2010. The process may then use this year as the effective age of the target property (because with the improvements in 2018, the structure/property “looks” or “acts” younger than it actually is). In this case, since the target structure was built in 2010 and its condition in 2018 is essentially the same as the condition in 2010, the process may then determine that, while the actual age of the structure in 2018 is really 8 years old, the “effective age” may reflect that the structure, in 2018, is actually in as good a physical condition as it was when it was originally built back in 2010. Accordingly, the effective age of this exemplary target structure may match the actual age up until the point when there is a major job/improvement that significantly increases the physical condition of the target structure, at which point the effective age may “jump” down to a “younger” effective age.

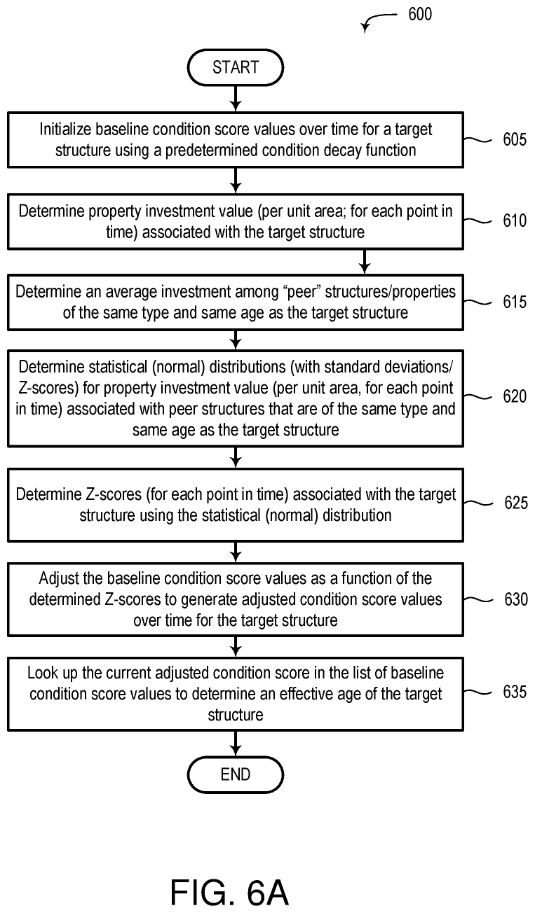

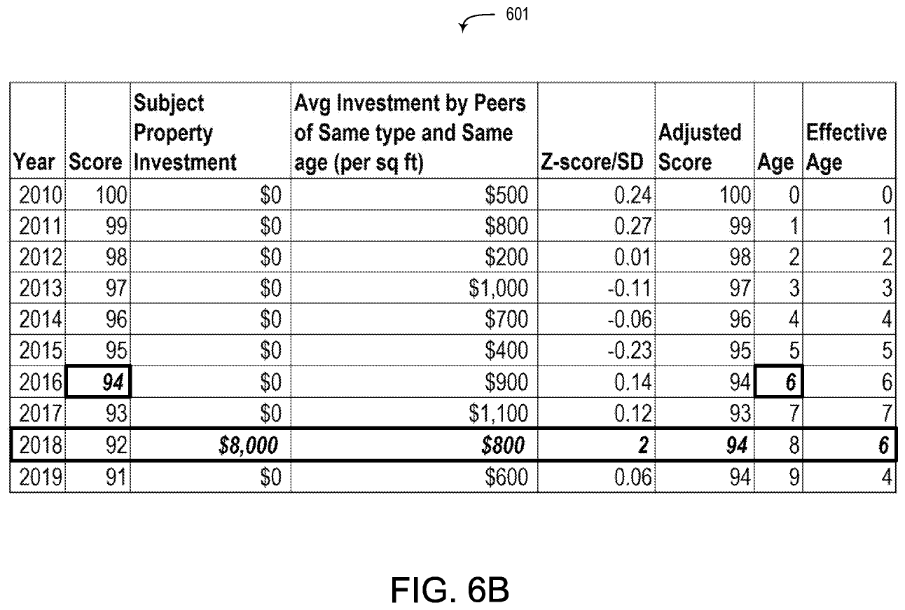

FIG. 6A depicts a flowchart of an exemplary fourth embodiment of a continuous condition score and effective age determination process. A process 600 may be executed by a computer processor (e.g., CPU 205) according to computer instructions stored in memory (e.g., NVM 215). The process 600 starts at step 605 with initialization of a set of baseline condition scores over time (e.g., each year) for a given target structure using a predetermined decay function (e.g., an exponential function). The baseline score for each year a property has existed is computed uniformly given the assumptions above. As a result, all properties of a given age may have an identical baseline condition score. Next, at step 610, the process determines a property investment value associated with the target structure. The property investment value may be an investment amount in permitted projects, per unit area, for each year of the target property's existence. Next, at step 615, the process determines an average investment among “peer” structures/properties of the same (or similar) type and same (or similar) age. For example, if the target structure is a single home dwelling built in 1975, the process may search the source data records and retrieve all source data records pertaining to all single home dwellings built in the years 1974-1976. The process may then calculate an average investment amount for each point in time (each year) across all of the retrieved records pertaining to all single home dwellings built in the years 1974-1976. Next, at step 620, the process determines statistical distributions for property investment value associated with peer structures that are of the same type and same age as the target structure. The statistical distributions may be assumed to be a normal distribution, in some examples. A given determined distribution may be represented as investment per unit area for a given year across properties with a same (or similar) age and same (or similar) type of structure. Next, at step 625, the process determines Z-scores (for each point in time) associated with the target structure using the determined statistical distribution. Next, at step 630, the baseline condition scores are then adjusted as a function of: (1) the respective z-scores of investments in permitted projects for the target property, and (2) the average investment of peer structures of the same type/age; to generate a set of actual (final) condition score values over time for the target property. For example, the baseline score may be adjusted if both: (1) an investment in the subject property in a given point in time is greater than a predetermined job cost threshold, and (2) the calculated z-score at the given point in time is greater than a predetermined deviation threshold; and not adjusted otherwise. If both of these threshold conditions are met, then the baseline condition scores are then adjusted by the respective z-scores of investments in permitted projects for the target property to generate a set of actual (final) condition score values over time for the target property. This results in the Continuous Condition Score.

Because the generated Continuous Condition Score considers a useful life of a property, the generated score may be converted into an “effective age” of the target structure as well. At step 635, the process may use the current actual condition score (e.g., in the present year) to look up a closest baseline condition score (determined at step 605). The closest baseline condition score to the current actual condition score may be associated with an actual age of the structure. This associated actual age may then be used as the “effective age” of the target structure.

FIG. 6B depicts a table 601 with exemplary data illustrating application of the process in FIG. 6A. In a first column is a list of points in time (e.g., years). In this exemplary depiction, a target structure was built in 2010, and the present year is 2019. Therefore, per step 605, the process 600 will generate a set of baseline condition scores (second column) for the target structure. In a third column is a list of investments in the target structure/property by year (per step 610). These investment values may be collected from records stored in at least one database, for example. In this case, no investments were made in the target structure until 2018, where an investment of $8,000 was made. At step 615, the process determines an average investment among “peer” structures/properties of the same (or similar) type and same (or similar) age as the target structure. In this example, the target structure is a duplex built in 2010, therefore, the process may search the source data records and retrieve all source data records pertaining to all duplexes built in the year 2010, for example. The process may then calculate an average investment amount for each year (fourth column) across all of the retrieved records pertaining to duplexes built in the year 2010. In this case, the average investment amounts for each year for duplexes built in 2010 is in the range of $200-$1,110. At step 620, the process 600 determines the parameters of statistical distributions for property investment value associated with peer structures that are of the same type and same age as the target structure. In this example, the distributions are normal distributions with mean values for each year listed in the fourth column (already calculated at step 615). Next, at step 625, the process will determine z-scores associated with the target structure that are relative to the underlying distributions determined in the previous step. For example, the fifth column includes a list of z-scores associated with the target structure for each year of the structure's existence. Since, in this case, there was no investment in the target structure in years 2010-2017, the determined z-scores for these years is about 0 (+/−some error). However, in 2018, a major job valued at $8,000 results in the z-score for that year being 2 standard deviations (>=95%). Therefore, at step 630, the baseline condition scores are then adjusted as a function of: (1) the respective z-scores of investments in permitted projects for the target property, and (2) the average investment of peer structures of the same type/age; to generate a set of actual (final) condition score values over time for the target property. In this example, the baseline score is adjusted if both: (1) the investment in the subject property in in 2018 is greater than a predetermined job cost threshold, and (2) the calculated z-score in 2018 is greater than a predetermined deviation threshold; and not adjusted otherwise. Using a predetermined job cost threshold of $5,000, and a predetermined deviation threshold of 1 standard deviation, the 2018 numbers for the subject property meet the above two criteria. Therefore, the baseline condition scores are then adjusted as a function of the 2018 z-score to generate a (final) condition score value in 2018. In this case, the z-score may be simply added to the baseline score for 2018 to arrive at the adjusted score. Therefore, in 2018, the target structure's baseline score may be only 92, but the adjusted/actual score may be at around 94. Accordingly, the major improvement on year 2018 may result in a “jump” in the continuous condition score of the target structure, similar to the jumps depicted in FIG. 3, which may represent a significant improvement in the overall quality and physical condition of the target structure.

Furthermore, the adjusted continuous condition score may be used to determine an “effective age” of the target structure (eighth column, vs. the actual age in the seventh column). For example, the adjusted score at year 2018 is 94. According to step 635 then, the process will look up the value 94 (or the value closest to 94) in the set of baseline scores (second column). In this case, the value 94 in the second column is associated with the year 2016. The process may then use this year as the effective age of the target property (because with the improvements in 2018, the structure/property “looks” or “acts” younger than it actually is). In this case, since the target structure was built in 2010 and its condition in 2018 is essentially the same as the condition in 2016, the process may then determine that, while the actual age of the structure in 2018 is really 8 years old, the “effective age” may only be 6 years old (as this was how old the structure was back in 2016 when the baseline score was close to the actual/adjusted score in 2018). Accordingly, the effective age of this exemplary target structure may match the actual age up until the point when there is a major job/improvement that significantly increases the physical condition of the target structure, at which point the effective age may “jump” down to a “younger” effective age.

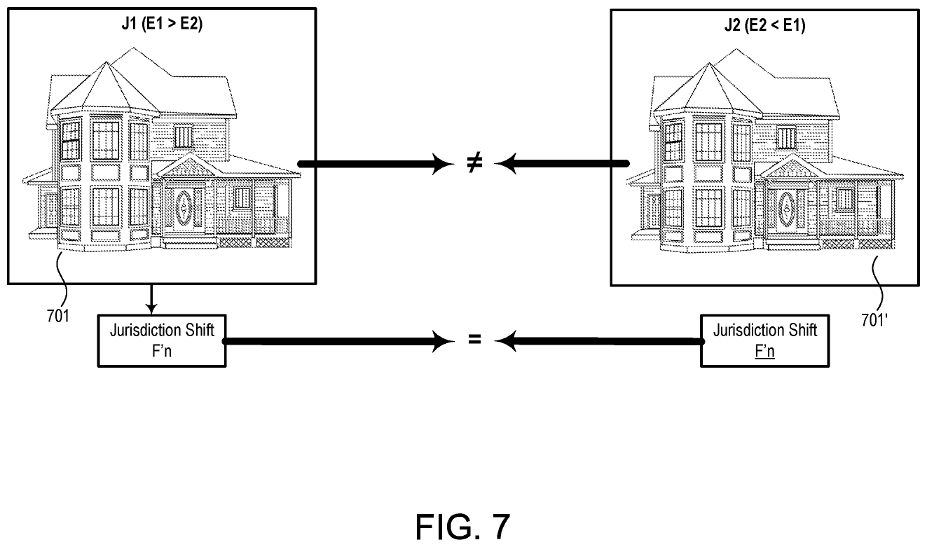

FIG. 7 depicts a diagram of an exemplary jurisdictional condition score shift scenario. In the exemplary scenario of FIG. 7, two properties 701 and 701′ (e.g., residential houses) reside in two respective (separate) jurisdictions J1 and J2. In this scenario, the first property 701 is exactly the same as the second property 701′ (e.g., same house make/model, same year built, same maintenance record, same improvements, same overall condition). In this scenario, the first jurisdiction J1 enforces that building permits be pulled more strictly than the second jurisdiction J2 (which is indicated by an enforcement level E1 of the first jurisdiction J1 being greater than an enforcement level E2 of the second jurisdiction J2). For the same type of work, the first property 701 in the high enforcement jurisdiction J1 is likely to be perceived as being of better condition than the second property 701′ in the low enforcement jurisdiction J2, simply due to the better records available in the first jurisdiction J1 (as indicated by the not-equal-to sign). To control for this artificial discrepancy, various systems and methods disclosed herein may benchmark each jurisdiction against a generic (national) distribution of condition scores, and then compare jurisdictions after benchmarking.

More specifically, and as seen in FIG. 7, a jurisdiction shift function (F′n) is constructed to enable comparability of property conditions across jurisdictions having varying levels of enforcement (e.g., low, medium, and high). Since permitting regulations, enforcement and tendencies vary across each building permit authority, it may be misleading to compare the condition of two properties in separate jurisdictions without adjusting for the latent uniqueness of each jurisdiction. Accordingly, by passing the (un-normalized) condition scores for the properties 701 and 701′ through the jurisdiction shift function, the jurisdiction-shifted condition score of the first property 701 is equal to the jurisdiction-shifted condition score of the first property 701′, since the state and condition of the two properties is the same, and the discrepancy in the jurisdiction enforcement (E1>E2) between the two jurisdiction J1 and J2 has been controlled for (normalized) using the jurisdiction shift function.

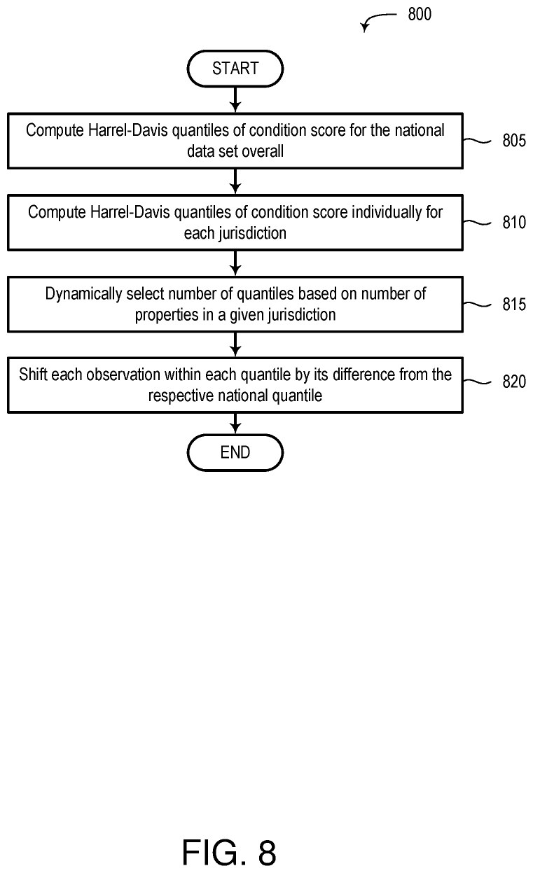

FIG. 8 depicts a flowchart of an exemplary computer-implemented jurisdictional score shift process. A process 800 may be executed by a computer processor (e.g., CPU 205) according to computer instructions stored in memory (e.g., NVM 215). The computer-implemented jurisdictional score shift process starts with computing 805 Harrel-Davis quantiles of condition score for a generic (national) data set overall. The Harrel-Davis quantile method was disclosed in Harrell F E, Davis C E (1982): A new distribution-free quantile estimator. Biometrika 69:635-640. Next, the method computes 810 Harrel-Davis quantiles of condition score individually for each jurisdiction (e.g., J1 and J2 separately). Next, the number of quantiles (e.g., 4, 8, 16) is dynamically selected 815 based on number of properties in a given jurisdiction. For example, if jurisdiction J1 has 10,000 properties, then the number of quantiles may be 100. In an exemplary implementation, it may be required that there be a minimum of 20 properties in each quantile, with the number of quantiles being determined by the most limiting jurisdiction for a jurisdiction to jurisdiction comparison, and no shift being performed with 2 or fewer quantiles. Finally, each observation (e.g., each data point corresponding to the un-normalized condition score for a given property) is shifted 820 within each jurisdiction-specific quantile by each observations difference from the respective generic (national) quantile. The final shifting of each property's jurisdiction score based on the national vs. jurisdiction-specific quantile comparisons effectively shifts the distribution of condition scores for each jurisdiction relative to a common benchmark (e.g., the national distribution), thus advantageously allowing comparability across jurisdictions.

An example of change in condition score for a pair of properties is as follows. The unadjusted/non-normalized condition scores for a first residential property (FL_WestPalmBeach) was previously calculated as being 97.01 (on a 0-100 point scale, using the methods disclosed in U.S. Provisional Application Ser. No. 62/888,835). The unadjusted/non-normalized condition scores for a second residential property (CO_Centennial) was previously calculated as being 97.59 (on a 0-100 point scale, using the methods disclosed in U.S. Provisional Application Ser. No. 62/888,835). Using the computer-implemented process illustrated in FIG. 8, each of the condition scores above is processed through the jurisdiction shift function (e.g., utilizing the H-D quantiles applied to national/jurisdiction-specific data). After processing through the jurisdiction shift function, a jurisdiction-normalized/shifted condition score of the first residential property (FL_WestPalmBeach) is now 88.30, while a jurisdiction-normalized/shifted condition score of the second residential property (CO_Centennial) is now 97.50. Before the shift function was applied, these two different properties (in FL vs. CO) would be considered to be of equivalent quality (e.g., ˜97/100). However, the nature of permit issuance is significantly different between these two jurisdictions—permits are enforced more strictly in West Palm Beach, Fla. than Centennial, CO (likely due to regulations around hurricane resistance, for example). This jurisdictional and regulatory artifact artificially inflates the condition of the first (FL) property. Accordingly, the jurisdictional shift function allows a more “like-to-like” or “apples-to-apples” comparison of quality for a collection of properties, such that the CO property is actually indicated to be of higher benchmarked quality than the FL property (once the jurisdictional enforcement levels have been accounted for, using the condition score jurisdiction shift function).

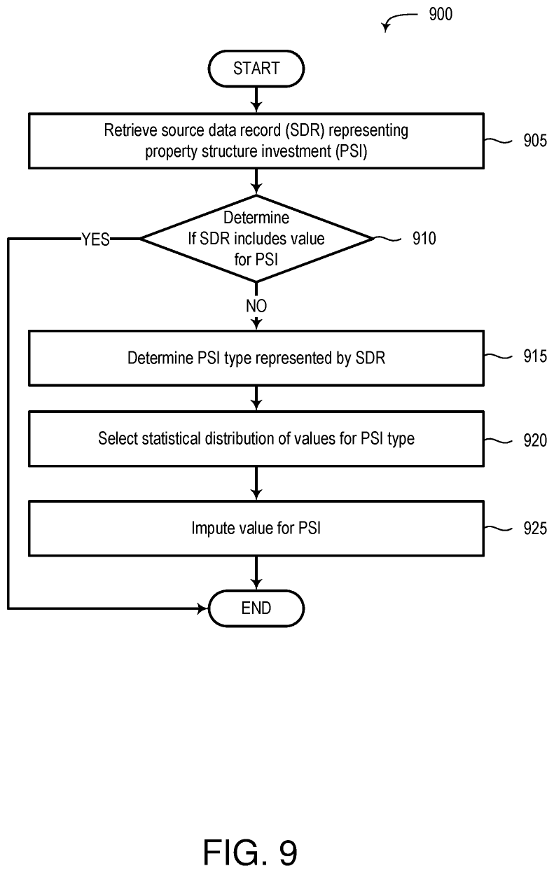

FIG. 9 depicts a flowchart of an exemplary computer-implemented value imputation process. A process 900 may be executed by a computer processor (e.g., CPU 205) according to computer instructions stored in memory (e.g., NVM 215). Process 900 begins with retrieving 905 a source data record representing at least one property structure investment (PSI). The SDR is then evaluated to determine 910 if the SDR includes a value(s) for the PSI(s). The value may be, by way of example and not limitation, a total job cost, a per square foot job cost, or a proxy for value (e.g., a permit fee proportional to improvement value). If a value is included in the SDR, no value imputation is needed and the method ends.

If no value is included in the SDR, the type of PSI represented by the SDR is determined 915. The PSI may, by way of example and not limitation, be a kitchen remodel, a bath remodel, a pluming repair, an electricity repair, a roof replacement, a foundation repair, a bedroom addition. PSIs may be advantageously classified by structure type (e.g., residential, commercial, industrial, retail), room or purpose (e.g, bathroom, living, kitchen, bedroom, lobby, office, waiting room, treatment room, or warehousing area), other characteristics, or some combination thereof. Once the type of PSI is determined, an appropriate statistical distribution of PSI values is selected 920, at least according to the PSI characteristics. For example, the distribution may be selected according to one or more classification (discussed previously), by location of the target structure, time period in which the PSI occurred, according to a peer group, or some combination thereof. The values may be calculated and normalized, for example, per square foot. Values treated per square foot may advantageously allow comparison across structures of various sizes.

Once a statistical distribution(s) has been selected, a value(s) is imputed 925 for the PSI(s) in the SDR. For example, suppose an SDR indicates that a PSI of a 200 square foot kitchen remodel was completed in 2018 on a 2000 square foot single family residence in Austin, Tex., but gives no associated value information. A normal distribution for a kitchen remodel in 2018 in Austin, Tex., for example, may be selected, and may indicate an associated value of $80/square foot. Accordingly, a value of $80/sf over 200 sf, or $16,000 total, may be imputed to the PSI. If that was the only PSI occurring in a given time increment, the individual, unscaled PIV may then be calculated, for example, as $16,000/2,000 square feet=$8/square foot. In a similar example, a normal distribution may be selected representing state, regional, or national peers, and may be scaled (e.g., shifted or multiplied) according to a statistical correlation between values in Austin, Tex. relative to the larger peer group selected.

Although various embodiments have been described with reference to the Figures, other embodiments are possible. For example, various units may be in units of cost per unit area. An exemplary algorithm for determining a continuous condition score may be as follows. An initial algorithmic step may include computing cumulative investment (using Job Cost) per square foot for each property. A next algorithmic step may include extracting square footage data from tax assessor records. A next algorithmic step may include determining a year built from a combination of the year built present in a permit file, or tax assessor records, if the permit file is blank/not available. A next algorithmic step may include generating a dataset for each year of a property's life (e.g., from age 0 in year built (with an underlying score of 100, for example) through present; there may be a new row for each year of that property's life). A next algorithmic step may include tracking the above cumulative investment calculation across each year of a property's life. A next algorithmic step may include normalizing the cumulative investment for each property. A next algorithmic step may include create distribution(s) of quality across all properties at given age. For example, a step may create z-scores of all properties at age 1, 2, 3 . . . separately. A next algorithmic step may include adjusting a property's age as a function of the property's z-score, and then cumulating the adjusted age over time. A next algorithmic step may include computing an effective age of property based on distribution assumptions. In some versions, an exponential decay may be assumed (thus the algorithm may use half-life equation(s) to compute effective age). Some implementations may use a gamma process or linear decay as underlying assumptions, for example.

In some examples, conditions for determining whether an improvement was “significant” or not may be determined using logical and mathematical operators. For example, in at least some embodiments, “significant” work may be determined by OR'ing three values: (1) whether the improvement cost is >X standard deviations away (e.g., >2 SD), (2) a hard-coded, user-customizable, dollar amount (e.g., >$10,000), and (3) a hard-coded, user-customizable, % of replacement cost (e.g., >3% of instantaneous replacement cost).

Some aspects of embodiments may be implemented as a computer system. For example, various implementations may include digital and/or analog circuitry, computer hardware, firmware, software, or combinations thereof. Apparatus elements can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Some embodiments may be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the memory can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from a source to a receiver over a dedicated physical link (e.g., fiber optic link, infrared link, ultrasonic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, FireWire, ATA/IDE, RS-232, RS-422, RS-485, 802.11 a/b/g/n, Wi-Fi, WiFi-Direct, Li-Fi, BlueTooth, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

In various embodiments, a computer system may include non-transitory memory. The memory may be connected to the one or more processors, which may be configured for storing data and computer readable instructions, including processor executable program instructions. The data and computer readable instructions may be accessible to the one or more processors. The processor executable program instructions, when executed by the one or more processors, may cause the one or more processors to perform various operations.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

1. A computer program product comprising a program of instructions tangibly embodied on a computer readable medium wherein when the instructions are executed on a processor, the processor causes condition and determination operations to be performed on a plurality of source data records (SDRs) originating from a plurality of data stores, each SDR associated with at least one of a plurality of man-made physical structures (MMPSs) and representing at least one physical structure improvement (PSI) thereto, to determine an objective condition metric of a target structure selected from the plurality of MMPSs, the operations comprising:
determining baseline condition score values for a plurality of predetermined time increments (TIs) for the target structure using a predetermined condition decay function, the predetermined condition decay function comprising at least one of: an exponential function, a linear function, and a gamma decay process;
determining for each TI a normal statistical distribution of property investment values (PIVs) of a plurality of peer structures from the SDRs associated therewith, the plurality of peer structures being selected from the plurality of MMPSs;
determining an individual PIV for each TI for the target structure from at least one SDR associated therewith;
determining at least one z-score for each TI relating the individual PIV of the target structure to the corresponding normal distribution of PIVs of the plurality of peer structures;
scaling the individual PIV for each TI for the target structure according to the z-score; and
generating adjusted condition score values for each TI by adjusting the baseline condition score values according to the scaled individual PIV.

2. A computer program product comprising a program of instructions tangibly embodied on a computer readable medium wherein when the instructions are executed on a processor, the processor causes condition and determination operations to be performed on a plurality of source data records (SDRs) originating from a plurality of data stores, each SDR associated with at least one of a plurality of man-made physical structures (MMPSs) and representing at least one physical structure improvement (PSI) thereto, to determine an objective condition metric of a target structure selected from the plurality of MMPSs, the operations comprising:
determining baseline condition score values for a plurality of predetermined time increments (TIs) for the target structure using a predetermined condition decay function;
determining statistical distributions of property investment values (PIVs) of a plurality of peer structures from the SDRs associated therewith, the plurality of peer structures being selected from the plurality of MMPSs;
determining an individual PIV for each TI for the target structure from at least one SDR associated therewith;
determining at least one statistical score for each TI relating the individual PIV of the target structure to the statistical distribution of PIVs of the plurality of peer structures;
scaling the individual PIV for each TI for the target structure according to the at least one statistical score; and
generating adjusted condition score values for each TI by adjusting the baseline condition score values according to the scaled individual PIV.

3. The computer program product of claim 2, further comprising determining a PIV for each SDR by dividing a total value of the SDR by a size of the associated structure, such that the PIV is correlated to a standard size unit.

4. The computer program product of claim 2, wherein:
the statistical distributions comprise a normal distribution for each TI, and
the at least one statistical score comprises a z-score.

5. The computer program product of claim 2, wherein the predetermined TIs are years relative to a build date of the target structure.

6. The computer program product of claim 2, further comprising performing value imputation operations for each SDR representing at least one PSI but providing no value thereof, the value imputation operations comprising:
determining a PSI type represented by the SDR;
selecting at least one statistical distribution of values for the PSI according to the PSI type, the PSI statistical distribution being generated from SDRs associated with a plurality of structures; and
imputing a value for the PSI therefrom.

7. The computer program product of claim 2, further comprising jurisdictional standardization operations, the jurisdictional standardization operations comprising:
determining, for each TI, a quantile shift score associated with at least one jurisdiction in which the target structure is located; and
generating a standardized condition score value for each TI by shifting the adjusted condition score values according to the quantile shift scores.

8. The computer program product of claim 7, wherein determining a quantile shift score for each TI comprises:
computing a plurality of Harrel-Davis quantiles of condition score for generic data set;
computing a plurality of Harrel-Davis quantiles of condition score individual for a plurality of jursidictions; and
selecting a number of quantiles based on a number of physical man-made structures in at least one jurisdiction.

9. The computer program product of claim 2, wherein the predetermined condition decay function is at least one of: an exponential function, a gamma process, and a linear function.

10. The computer program product of claim 9, wherein:
the predetermined condition decay function is an exponential function having a half-life variable and a useful life variable,
the half-life variable equals 50 years, and
the useful life variable equals 100 years.

11. The computer program product of claim 2, wherein at least some SDRs are building permit records.

12. The computer program product of claim 2, further comprising looking up an adjusted condition score for a current time increment in the plurality of baseline condition score values to determine an effective age of the target structure.

13. A computer-implemented method comprising:
directing a processor to perform condition and determination operations on a plurality of source data records (SDRs) originating from a plurality of data stores, each SDR associated with at least one of a plurality of man-made physical structures and representing at least one physical structure improvement (PSI) thereto, to determine an objective condition metric of a target structure selected from the plurality of man-made physical structures, the operations comprising:
determining initial baseline condition score values for a plurality of predetermined time increments (TIs) for the target structure using a predetermined condition decay function;
determining statistical distributions of property investment values (PIVs) of a plurality of peer structures from the SDRs associated therewith, the plurality of peer structures being selected from the plurality of man-made physical structures;
determining an individual PIV for each TI for the target structure from at least one SDR associated therewith;
determining at least one statistical score for each TI relating the individual PIV of the target structure to the statistical distribution of PIVs of the plurality of peer structures;
scaling the individual PIV for each TI for the target structure according to the at least one statistical score; and
generating adjusted condition score values for each predetermined TI by adjusting the baseline condition score values according to the scaled individual PIV.

14. The method of claim 13, further comprising determining a PIV for each SDR by dividing a total value of the SDR by a size of the associated structure, such that the PIV is correlated to a standard size unit.

15. The method of claim 13, wherein:
the statistical distributions comprise a normal distribution for each TI, and
the at least one statistical score comprises a z-score.

16. The method of claim 13, further comprising performing value imputation operations for each SDR representing at least one PSI but providing no value thereof, the value imputation operations comprising:
determining a PSI type represented by the SDR;
selecting at least one statistical distribution of values for the PSI according to the PSI type, the PSI statistical distribution being generated from SDRs associated with a plurality of structures; and
imputing a value for the PSI therefrom.

17. The method of claim 13, further comprising jurisdictional standardization operations, the jurisdictional standardization operations comprising:
determining, for each TI, a quantile shift score associated with at least one jurisdiction in which the target structure is located; and
generating a standardized condition score value for each TI by shifting the adjusted condition score values according to the quantile shift scores.

18. The method of claim 17, wherein determining a quantile shift score for each TI comprises:
computing a plurality of Harrel-Davis quantiles of condition score for generic data set;
computing a plurality of Harrel-Davis quantiles of condition score individual for a plurality of jursidictions; and
selecting a number of quantiles based on a number of physical man-made structures in at least one jurisdiction.

19. The method of claim 13, wherein the predetermined condition decay function is at least one of: an exponential function, a gamma process, and a linear function.

20. The method of claim 19, wherein:
the predetermined condition decay function is an exponential function having a half-life variable and a useful life variable,
the half-life variable equals 50 years, and
the useful life variable equals 100 years.
